(19) United States
(12) Patent Application Publication
(10) Pub. No.: US 2004/0023052 A1
(43) Pub. Date: Feb. 5, 2004

(54) Matte surface film

(76) Inventor: Benoit Ambroise, Montmedy (FR)

Correspondence Address: EXXONMOBIL CHEMICAL COMPANY, P O BOX 2149, BAYTOWN, TX, 77522-2149, US

(21) Appl. No.: 10/210,346

(22) Filed: Jul. 31, 2002

(51) Int. Cl. B32B 27/08

(52) U.S. Cl. 428/515; 428/523

(57) ABSTRACT

A multi-layered polymeric film comprising a core layer comprising a polyolefin, and a first skin layer comprising a low melting point polyolefin and a matte producing agent, and a method for producing same.

### FIELD OF THE INVENTION

The present invention relates to a matte surface film. More particularly, the present invention relates to a multilayer polyolefin matte surface film comprising a matte producing agent.

### BACKGROUND OF THE INVENTION

Matte surface films have a variety of useful purposes. Primarily, they form a good background for displaying printed or artful images on the film. The images can be printed onto the matte surface or on the opposite side by any conventional plastic printing process.

Mobil Chemical Company film product “70 MLT” is a matte surface biaxially oriented multilayer film. The base layer is oriented polypropylene and the matte surface skin layer comprises a mixture of polyethylenes and an ethylene-propylene-butene-1 terpolymer. The matte surface film has a dull surface appearance; that is, it is not shiny or glossy. Such a surface appearance is not typical of most biaxially oriented films used in packaging but is advantageous in that it provides an unusual appearance when reverse printed on the side opposite to the matte surface.

U.S. Pat. No. 5,492,757 to Schuhmann, et al. discloses an opaque, matte, multilayer polypropylene film having at least one matte surface which includes at least one base layer and at least one interlayer, and an outer layer applied to this interlayer. The base layer includes polypropylene and fillers. The interlayer includes a mixture or blend of two components I or II. Component I is a propylene homopolymer or a copolymer of alpha-olefins having 2 to 10 carbon atoms, or a terpolymer of alpha-olefins having 2 to 10 carbon atoms or a mixture or blend of said polymers. Component II is an HDPE or a blend of HDPE and a propylene homopolymer or a copolymer of alpha-olefins having 2 to 10 carbon atoms or a terpolymer having 2 to 10 carbon atoms. The outer layer essentially includes a propylene homopolymer or a copolymer of alpha-olefins having 2 to 10 carbon atoms or a terpolymer of alpha-olefins having 2 to 10 carbon atoms or a mixture or blend of said polymers. U.S. Pat. No. 5,492,757 is disclosed herein by reference in its entirety.

U.S. Pat. No. 5,006,394 to Baird, et. al. discloses a polymeric multilayer film structure having a high percentage of fillers. The fillers are concentrated in a separate filler containing layer having about 5 to about 20 percent of the thickness of the total multilayer film. The filler containing layer is coextruded with a base layer comprising the balance of the thickness of the multilayer film. By keeping the filler containing layer thin, relative to the total film thickness, a multilayer film having a filler concentration up to about 60 weight percent is achievable without significantly adversely affecting the material properties of the multilayer film structure. U.S. Pat. No. 5,006,394 is disclosed herein by reference in its entirety.

U.S. Pat. No. 6,087,015 to Cretekos, et al. discloses a thermoplastic film having a matte surface comprising: a core layer of a thermoplastic polymer, the core layer having a first side and a second side, and a matte surface layer on a first side of the core layer, the matte surface layer comprising a blend of (i) a copolymer of ethylene and propylene or a terpolymer of ethylene, propylene and a C4 to C10 alpha-olefin or a propylene homopolymer; (ii) an ethylene polymer and (iii) a polydialkylsiloxane selected from the group consisting of (1) a polydialkylsiloxane having a number average molecular weight above about 250,000, typically above about 300,000 and a viscosity of above about 10,000,000 cSt, usually ranging from about 15,000,000 to about 20,000,000 cSt., and (2) a polydialkylsiloxane functionalized polyolefin. The external surface of the matte surface layer demonstrates a coefficient of friction ranging from about 0.1 to about 0.85 as determined by ASTM D1894 with an 18.14 kg (4 lb.) pound sled. U.S. Pat. No. 6,087,015 is disclosed herein by reference in its entirety.

U.S. Pat. No. 6,033,839 to Smith, et al. discloses a thermally processable imaging element comprising: (1) a support; (2) a thermally processable imaging layer on one side of the support; and (3) a protective layer comprising: (A) a film-forming binder; (B) matte particles comprising a core surrounded by said film-forming binder. U.S. Pat. No. 6,033,839 is disclosed herein by reference in its entirety.

U.S. Pat. No. 4,303,708 to Gebhardt, et al. discloses an opaque film of thermoplastic organic material which has been oriented by biaxial stretching, comprising a base layer of a polymer or copolymer of an alpha-olefin having 2 to 6 carbon atoms containing between about 1 and 25 percent by weight, calculated on the weight of the polymer, of finely distributed solid particles ranging in size from about 0.2 to 20 mu m, and carried on at least one surface of the base layer, a heat-sealable layer comprising a copolymer of propylene with ethylene, a copolymer of propylene with butene, or a terpolymer of propylene with ethylene and a further alpha-olefin having from 4 to 10 carbon atoms. Also disclosed are a method of making this film and a package made therefrom. U.S. Pat. No. 4,303,708 is disclosed herein by reference in its entirety.

U.S. Pat. No. 5,521,002 to Sneed discloses an ink receiving matte coating composition and ink receiving media ink jet printing which comprises a transparent, translucent, or opaque base support, such as polyester film, on to which a matte, opaque ink receptive layer is applied on at least one side. The ink receptive matte coating composition of the present invention is comprised of one or more hydrophilic, water soluble polymers, a hydrophobic cellulose ether polymer, a polyalkylene glycol, and a filler, or filler/pigment combination, for making the layer opaque. The ink receiving media described herein allows for quick drying of ink jet printing inks while controlling the edge sharpness of the printed areas and is resistant to moisture and humidity effects, such as fingerprinting, slowed ink drying times, and easy removal of the coated ink receptive layer with moisture, thus increasing its value as an archivable storage media for ink jet printed images. U.S. Pat. No. 5,521,002 is disclosed herein by reference in its entirety.

U.S. Pat. No. 5,516,563 to Schumann, et al. discloses an opaque, matte, multilayer polypropylene film. It includes at least one base layer comprising polypropylene or a polypropylene mixture and fillers, and at least one outer layer which contains a mixture or a blend of two components I and II. Component I essentially contains a propylene homopolymer or a copolymer of an alpha-olefin having 2 to 10 carbon atoms or a terpolymer of an alpha-olefin having 2 to 10 carbon atoms or a mixture of two or more of said homopolymers, copolymers and terpolymers or a blend of two or more of said homopolymers, copolymers and terpolymers. Component II essentially contains an HDPE having an MFI (50 N/190° C.) of from greater than 1 to 50 g/10 min, measured in accordance with DIN 53 735, or a blend of two components A and B. Blend component A is essentially an HDPE having an MFI (50 N/190° C.) of from greater than 1 to 50 g/10 min, measured in accordance with DIN 53 735. Blend component B is essentially a propylene homopolymer or a copolymer of an alpha-olefin having 2 to 10 carbon atoms or a terpolymer of an alpha-olefin having 2 to 10 carbon atoms or a mixture of two or more of said homopolymers, copolymers and terpolymers or a blend of two or more of said homopolymers, copolymers and terpolymers. The invention also relates to a process for the production of the multilayer polypropylene film and to the use of the film. U.S. Pat. No. 5,516,563 is disclosed herein by reference in its entirety.

U.S. Pat. No. 5,981,047 to Wilkie discloses a coextruded biaxially oriented polyolefin packaging film having a cold seal release layer, a core layer, and a cold seal receptive skin layer. The release layer is made of (A) about 10% to about 60% by weight ethylene-butylene random copolymer containing between 0% and about 6.0% by weight ethylene and between about 94% and 100% by weight butylene; (B) a blend of two polymers selected from the group consisting of polyethylene ionomers, syndiotactic homopolymer polypropylene, conventional polyethylenes having densities of between 0.91 and 0.965 gm/cm³, and metallocene-catalyzed polyethylene plastomers; and optionally (C) a non-migratory slip agent present in an amount sufficient to decrease the coefficient of friction of the release layer. Alternatively, the release layer may be made of a two-component blend of the ethylene-butylene random copolymer and high density polyethylene. The packaging films exhibit excellent cold seal release, coefficient of friction, and a matte finish surface without the need for migratory slip additives or an overprint varnish. U.S. Pat. No. 5,981,047 is disclosed herein by reference in its entirety.

### SUMMARY OF THE INVENTION

The present invention is directed to a multi-layered polymeric film comprising:

a) a core layer comprising a polyolefin; and

b) a first skin layer comprising a low melting point polyolefin and a matte producing agent.

Objects and advantages of the invention include one or more of the following:

To produce a matte surface film suitable for various applications such as imaging applications, packaging, and labels;

To produce a matte surface film that does not incorporate a blend of incompatible components;

To produce a matte surface film that does not have die build up due to incompatible components;

To produce a matte surface film comprising a matte producing agent in a polyolefin layer;

To produce a matte surface film that has good printability and good writeablity;

To produce a matte surface film that is not opaque;

To produce a matte surface film having good contact clarity;

To produce a matte surface film having improved anchorage of matte producing particles;

To produce a matte surface film that does not exhibit chalking; and

To produce a matte surface film having a rough surface and low gloss.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of several illustrative embodiments when read in conjunction with the accompanying drawings, wherein:

FIG. 1 is a cross sectional illustration of a five layered film according to the present invention;

FIG. 2 is a cross sectional illustration of a three layered film according to the present invention;

FIG. 3 is a cross sectional illustration of a four layered film according to the present invention; and

FIG. 4 is a cross sectional illustration of a two layered film according to the present invention.

### DETAILED DESCRIPTION OF THE DRAWINGS

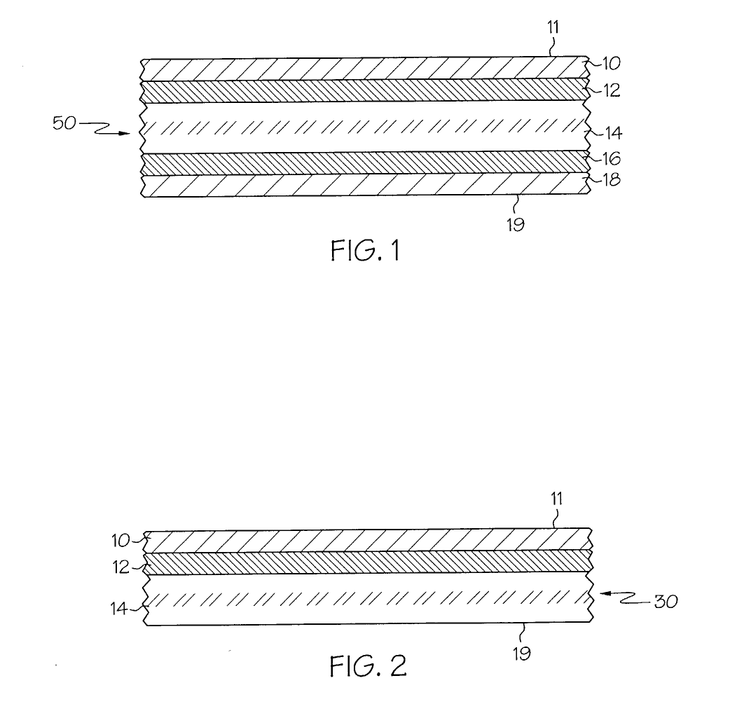

Referring now to FIG. 1 is a cross sectional view of a five layered film 50. The film 50 is comprised of a first surface 11, a first skin layer 10, a first intermediate or transition layer 12, a core layer 14, a second intermediate or transition layer 16, a second skin layer 18, and a second surface 19.

In one embodiment of a five layered film 50, the first skin layer 10 and/or the first transition layer 12 may comprise a matte producing agent. This film 50 allows for a matte finish on the first surface 11.

In a second embodiment of the film 50, the first skin layer 10 and/or the first transition layer 12 may comprise a matte producing agent as in the first embodiment, and the second skin layer 18 and/or the second transition layer 16 may also comprise a matte producing agent. This film 50 allows for one matte finish on the first surface 11 and a second matte finish on the second surface 19.

A third embodiment of the film 50 may include a first skin layer 10 which may comprise a relatively low melting point polyolefin including EP impact copolymers, EP copolymers, PB copolymers, EPB terpolymers, HDPE's, LDPE homopolymers, or LLDPE copolymers, and additionally may comprise a matte producing agent. The melting point of the lower melting point polyolefin of the skin layer 10 typically may be a few degrees lower (e.g., 5° C.) than the melting point of the core layer 14. In one variation, the first skin layer 10 may be from 0.5 to 3.0 microns thick. The first transition layer 12 may comprise a polyolefin including EP random copolymers, PB copolymers, EPB terpolymers, HDPE's, LLDPE's, or MDPE's. In another variation, the first transition layer 12 may be from 1 to 7 microns thick. In yet another variation, the core layer 14 may comprise a polyolefin including isotactic cavitated polypropylenes and may be from 5 to 50 microns thick. The second transition layer 16 may comprise a polyolefin including EP random copolymers, PB copolymers, EPB terpolymers, HDPE's, LLDPE's, or MDPE's. In another variation, the second transition layer 16 may be from 1 to 7 microns thick. (A transition layer also may be comprised of a mixture of materials contained in the core layer and the skin layer.) The second skin layer 18 may comprise a low melting point polyolefin including EP impact copolymers, EP copolymers, PB copolymers, EPB terpolymers, HDPE's, LDPE homopolymers, or LLDPE copolymers, and additionally may comprise a matte producing agent. In another variation, the second skin layer 18 may be 0.5 to 3.0 microns thick.

A fourth embodiment may comprise a first skin layer 10 which may comprise a polyolefin including EP impact copolymers, EP copolymers, PB copolymers, EPB terpolymers, HDPE's, LDPE homopolymers, or LLDPE copolymers. In one variation of the fourth embodiment, the first skin layer 10 may be from 0.5 to 3.0 microns thick. The first transition layer 12 may comprise a relatively low melting point polyolefin including EP random copolymers, PB copolymers, EPB terpolymers, HDPE's, LLDPE's, or MDPE's, and additionally may comprise a matte producing agent. In another variation, the first transition layer 12 may be from 1 to 7 microns thick. In a third variation, the core layer 14 may comprise a polyolefin including isotactic polypropylenes and may be 5 to 50 microns thick. The second transition layer 16 may comprise a low melting point polyolefin including EP random copolymers, PB copolymers, EPB terpolymers, HDPE's, LLDPE's, or MDPE's, and additionally may comprise a matte producing agent. In another variation, the second transition layer 16 may be from 1 to 7 microns thick. The second skin layer 18 may comprise a polyolefin including EP impact copolymers, EP copolymers, PB copolymers, EPB terpolymers, HDPE's, LDPE homopolymers, or LLDPE copolymers. In another variation, the second skin layer 18 may be from 0.5 to 3.0 microns thick.

Referring now to FIG. 2 is a cross sectional illustration of a three layered film 30. The illustrated film 30 comprises a first surface 11, a first skin layer 10, a first transition layer 12, a core layer 14, and a second surface 19.

In one embodiment of a three layered film 30, the first skin layer 10 and/or the first transition layer 12 may comprise a matte producing agent. This film 30 allows for a matte finish on the first surface 11.

In a second embodiment of a three layered film 30, there is a first skin layer 10 which may comprise a low melting point polyolefin including EP impact copolymers, EP copolymers, PB copolymers, EPB terpolymers, HDPE's, LDPE homopolymers, or LLDPE copolymers, and additionally may comprise a matte producing agent. In one variation of the second embodiment, the first skin layer 10 is 0.5 to 3.0 microns thick. The first transition layer 12 may comprise a polyolefin including EP random copolymers, PB copolymers, EPB terpolymers, HDPE's, LLDPE's, or MDPE's. In another variation, the first transition layer 12 is 1 to 7 microns thick. In a third variation, the core layer 14 may comprise a polyolefin including isotactic, cavitated polypropylenes and may be 5 to 50 microns thick.

A third embodiment of the three layered film 30 may comprise a first skin layer 10 which may comprise a polyolefin including EP impact copolymers, EP copolymers, PB copolymers, EPB terpolymers, HDPE's, LDPE homopolymers, or LLDPE copolymers. In one variation of the third embodiment, the first skin layer 10 may be from 0.5 to 3.0 microns thick. The first transition layer 12 may comprise a low melting point polyolefin, such as EP random copolymers, PB copolymers, EPB terpolymers, HDPE's, LLDPE's, or MDPE's, and additionally may comprise a matte producing agent. The term “low melting point polyolefin” may be defined to include a polyolefin having a melting point that is lower relative to other polyolefins in the film structure. In another variation, the first transition layer 12 may be from 1 to 7 microns thick. In a third variation, the core layer 14 may comprise a polyolefin including isotactic polypropylenes and may be 5 to 50 microns thick.

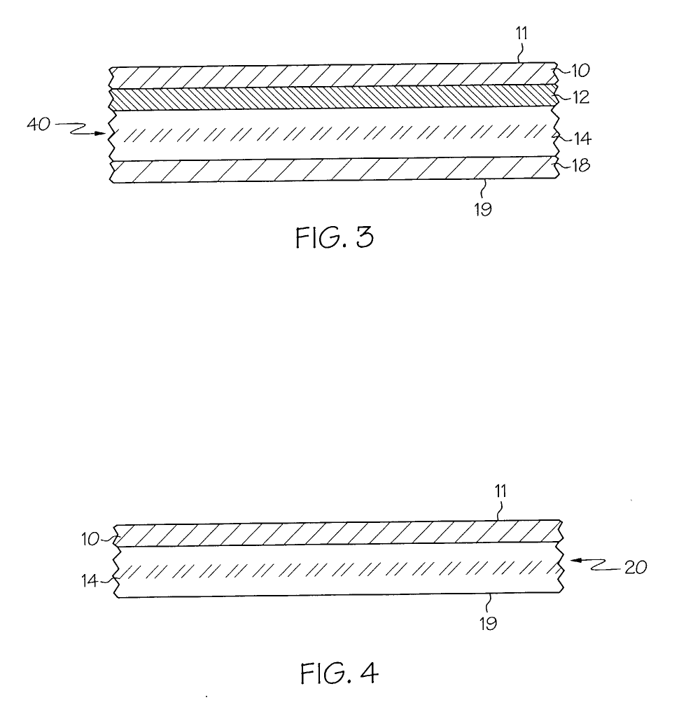

Referring now to FIG. 3 is an illustration of a cross sectional view of a four layered film 40. The film 40 may comprise a first surface 11, a first skin layer 10, a first transition layer 12, a core layer 14, a second skin layer 18, and a second surface 19.

There are multiple possible embodiments of the four layered film 40. The first skin layer 10, the first transition layer 12, and/or the second skin layer 18 may each, all, or in combination, optionally comprise a matte producing agent to yield a matte finish on the first surface 11 and/or the second surface 19. For example, in one embodiment, the first skin layer 10 may comprise a matte producing agent and a low melting point polyolefin. In a second embodiment, the first transition layer 12 comprises a matte producing agent and a low melting point polyolefin. In a third embodiment, the second skin layer 18 comprises a matte producing agent and a low melting point polyolefin. In a fourth embodiment both the first skin layer 10 and the second skin layer 18 comprise a matte producing agent and a low melting point polyolefin. In a fifth embodiment, both the first transition layer 12 and the second skin layer 18 comprise a matte producing agent and a low melting point polyolefin.

Referring now to FIG. 4 is a cross sectional view of a two layered film 20. The film 20 is comprised of a first surface 11, a first skin layer 10, a core layer 14, and a second surface 19.

There are multiple possible embodiments of the two layered film 20. The first skin layer 10 can optionally comprise a matte producing agent to yield a matte finish on the first surface 11. In one embodiment, the first skin layer 10 comprises a matte producing agent and a low melting point polyolefin.

In one embodiment, the core layer 14 may be cavitated to form an opaque film. Achieving opacity by void creation and opacifying compounds is known in the art. In another embodiment, the core layer 14 is not cavitated, and the film is substantially non-opaque or translucent.

Referring now to each of FIGS. 1, 2, 3 and 4, in one embodiment, when forming the core layer 14, as in U.S. Pat. Nos. 4,377,616; 4,632,869; 5,176,954; 5,397,635; 5,972,490; 4,758,396; 4,758,462; 4,652,489; 4,741,950; 4,594,211; and 6,004,664 the disclosures of which are incorporated herein by reference in their entirety, a master batch technique can be employed by either forming the void initiating particles in situ or in adding preformed spheres or particles to a molten thermoplastic matrix material. After the formation of a master batch, appropriate dilution of the system can be made by adding additional thermoplastic matrix material until the desired proportions are obtained. However, the components may also be directly mixed and extruded instead of utilizing a master batch method.

In another embodiment, to aid in providing the film with low light transmission, especially in the UV and blue wavelengths, iron oxide may be added to the core layer 14, such as in an amount of from about 1 to about 8% by weight, or in another embodiment about 2% to 4% by weight. Carbon black or other compounds may also be used. In another embodiment, aluminum may be added in an amount of from about 0 to about 1.0% by weight, in another embodiment from about 0.25% to about 0.75% by weight, and in another embodiment about 0.5% by weight. In another embodiment, the core layer 14 may also contains from about 0.5% by weight to about 3%-by weight of TiO₂ and/or talc. In one embodiment, from about 3% to about 9% by weight of inorganic particulate material such as TiO₂ and/or talc may be added to the melt mixture of the core layer 14 before or substantially during extrusion.

As a result of the particulate additions to the first skin layer 10, first transition layer 12, core layer 14, second transition layer 16, and/or second skin layer 18, the film may present a differential appearance. The term “differential” as applied to the film of this invention is intended to convey the concept of the distinctly dissimilar composition and appearance of each exposed film surface: the first surface 11 and the second surface 19. When viewed from the first surface 11, the film can have a matte finish or a glossy finish. It is contemplated that when the subject film is used in packaging, the second surface 19 may be positioned on the interior of a package and the first surface 11 may be positioned on the package exterior. When viewed from the second surface 19, the film can also have a matte finish or a glossy finish different than or the same as the first surface 11. If the film is being used in packaging and the second surface 19 is on the interior, then the second surface 19 can be plain, white, unprinted, and/or unfinished. But when viewed from the first surface 11, the film may present a matte finish or a glossy finish and an appealing appearance desirable for a package exterior.

The film may be selectively constructed to exhibit varying degrees of low opacity and high light transmission. A distinction is made between opacity and light transmission for the purposes of this invention. Opacity is the opposite of transparency and is a function of the scattering and reflection of light transmitted through the film. The film may exhibit some degree of haziness, milkiness, or opacity, but is preferably not opaque.

Hereafter are characteristics common to films according to this invention:

The surface is rough or matte. The roughness of the matte surface may be effected by the matte producing agents particles. Generally, the bigger the particles size, the rougher the surface.

The resulting film may provide a controlled degree of haziness or milkiness, without being highly opaque. However, if particles of matte producing agent, such as CaCO3, are added, such as in sufficient quantity or such as in a homopolymer intermediate layer, the film will be more opaque. According to this invention, the particles are added in a layer that is softer or has a lower melting point than the base or core layer of the film. At the temperature used to orient or stretch the film, the polymer matrix in the core layer is not melted whereas the polymer in the intermediate, skin, or other layer containing the matte producing agent layer is melted. The stretching process does not create cavities around the matte producing agent particles because the polymer is melted, thereby avoiding or minimizing cavitation effects and enhancing transparency as compared to typical oriented cavitated films.

Substantially any polymer or polymer blend that has a lower melting point than the one used in the base layer, may be used in the intermediate layer in combination with fillers.

At least two key advantages come from the lack of cavitation of the matte producing agent containing layer: First, the film is not opaque but is hazy. Contact clarity may be adjusted by tailoring the softness of the polymer in which the matte producing agent particles are added. Contact clarity is important when the film is reverse printed or when the film is applied on a surface can still be seen, such as a clear bottle.

Second, the anchorage of the particles is better. If particles were included in a traditionally cavitated layer film, polymer layer, many of the particles near the surface of the layer would be loose and may be rubbed off from the film, even when the matte producing agent containing layer is covered by a thin outer layer. Loose particles cause problems for converters and end-users.

The polyolefin contemplated as the matrix material in the core layer 14 may comprise polypropylene, polyethylene, polybutene, and copolymers and blends thereof. One embodiment may include a polypropylene homopolymer containing at least about 80% by weight of isotactic polypropylene, wherein it is preferred that the polypropylene have a melt flow index of from about 2 to 10 g/l 0 min. Another embodiment may include a high density polyethylene having a density of 0.95 g/cc or greater. In one embodiment, the materials that may be used for the core layer 14 include materials that have a melting point at least about 5° C. higher than the materials used in the skin and/or transition layers that include a matte producing agent.

The polymers contemplated herein for any layer that may include a matte producing agent therein, such as the first skin layer 10, first transition layer 12, second transition layer 16, and second skin layer 18 may be selected from those polymers typically employed in the manufacture of multi-layered films. In one embodiment, the materials that may be used for the first skin layer 10, first transition layer 12, second transition layer 16, and/or second skin layer 18 that include a matte producing agent include materials that have a melting point at least about 5° C. lower than the materials used in the core layer 14

Typical examples of materials which are suitable for use as the skin and transition layers are coextrudable materials, including materials which may form a seal upon application of elevated temperatures and at least slight pressure. Examples of polymeric materials which can be used for a sealing layer include olefinic homo-, co-, or terpolymers. The olefinic monomers can comprise 2 to 8 carbon atoms. Specific examples include polypropylene, ethylene-propylene random copolymer, ethylene-butene-1 copolymer, ethylene-propylene-butene-1 terpolymer, propylene-butene copolymer, high density polyethylene, low density polyethylene, linear low density polyethylene, very low density polyethylene, metallocene-catalyzed polyethylene, metallocene-catalyzed polymers known by the term plastomer, metallocene-catalyzed ethylene-hexene copolymer, metallocene-catalyzed ethylene-butene copolymer, metallocene-catalyzed ethylene-octene copolymer, ethylene-methacrylic acid copolymer, ethylene-vinyl acetate copolymer and ionomer resin. A blend of the foregoing materials is also contemplated such as a blend of the plastomer and ethylene-butene copolymer.

Ethylene-propylene-butene-1 random terpolymers appropriate for use in the skin or transition layers of the present invention include those containing 1-5 weight percent random ethylene and 10-25 weight percent random butene-1, with the balance being made up of propylene. The amounts of the random ethylene and butene-1 components in these terpolymers are typically in the range of 10 to 25 weight percent (ethylene plus butene-1) based on the total amount of the copolymer.

The copolymers and terpolymers typically have a melt flow rate in the range of about 1.5 to 15 g/10 min, with a density of about 0.9 g/cc and a melting point in the range of about 115 to about 170° C.

In one embodiment, the exposed first surface 11 and/or second surface 19 may be treated in a known and conventional manner, e.g., by corona discharge, flame, or plasma treatment to improve its receptivity to inks and/or its suitability for such subsequent manufacturing operations as lamination.

In one embodiment, the exposed treated or untreated first surface 11 and/or second surface 19 may have applied to it (typically not on the matte side), coating compositions or substrates such as another polymer film or laminate; a metal foil such as aluminum foil; cellulosic webs, e.g. numerous varieties of paper such as corrugated paperboard, craft paper, glassine, cartonboard; non-woven tissue, e.g., spunbonded polyolefin fiber, melt-blown microfibers, etc. The application may employ a suitable adhesive, e.g., a hot melt adhesive such as low density polyethylene, ethylene-methacrylate copolymer, water-based adhesive such as polyvinylidene chloride latex, and the like. The film of the present invention may be laminated to another polyolefin film (eg: by thermal, adhesive, extrusion, etc).

In another embodiment, the first skin layer 10 and/or the second skin layer 18 may include a coating or metal layer applied thereto. U.S. Pat. Nos. 6,077,602; 6,013,353; 5,981,079; 5,972,496; 6,074,762; 6,025,059; and 5,888,648 disclose the use of coatings and/or metal layers on a film, and are disclosed herein by reference. Suitable coatings may include PVdC's or acrylics which serve to improve gloss, enhance machineability, and/or enhance ink adhesion; suitable metals may comprise aluminum.

In one embodiment, the first skin layer 10, first transition layer 12, second transition layer 16, and/or second skin layer 18 may include up to about 30% by wt., in another embodiment from about 2% to about 20% by wt., and in a yet another embodiment from about 3% to about 10% by wt., of a matte producing agent. Suitable matte surface producing agents may comprise conventional fillers such as aluminum oxide, aluminum sulfate, barium sulfate, magnesium carbonate, silicates, aluminum silicate (kaolin clay), magnesium silicate (talc), silicon dioxide, HDPE, polyesters, polybutylene terephthalate, styrenes, polyamides, and halogenated organic polymers. In another embodiment, the matte producing agent may comprise calcium carbonate. In still another embodiment, the matte producing agent may comprise titanium dioxide. These matte producing agents may be provided in any form or may be subjected in advance to various dispersion treatment in a manner known in the art. Compounded thermoplastics including one or more matte producing agents, many of which are commercially available, may be used with this invention as matte producing agents. Direct addition of a matte producing agent to an extrusion also may be useful in some embodiments. In another embodiment compounded thermoplastic concentrates including one or more matte producing agents are used (for example: Ampacet Pearl 70, Ampacet WHOP 70, Schulman Papermatch H5228, and Schulman PF92D.) In one embodiment it is contemplated that any one of the first skin layer 10, first transition layer 12, second transition layer 16, and second skin layer 18 that comprises a matte producing agent, will additionally comprise a low melting point polyolefin therewith. “Low melting point polyolefin” is a relative term that may be defined as any polyolefin that melts at a temperature at least about 5° C. below the melting point of the core layer 14. Suitable low melting point polyolefins and blends include but are not limited to ethylene propylene copolymer, propylene butylene copolymer, ethylene propylene butylene terpolymer, polymer of ethylene, copolymer of ethylene with another alpha-olefin. Blends include a mixture of two or more polyolefin resins such as a blend of polypropylene with polyethylene, and a blend of one polyolefin resin (polypropylene or polyethylene, both homopolymer or copolymer) with one non polyolefin resin such as EVOH, nylon or PETG. In various embodiments, low melting point polyolefins have a melting point lower than 160° c. In other embodiments, low melting point polyolefins have a melting point lower than 140° c. The low melting point polyolefin may be selected from the group consisting of ethylene-propylene copolymer, ethylene-propylene-butylene terpolymer, propylene-butylene copolymer, and blends thereof.

The first skin layer 10 and/or the second skin layer 18 may be heat sealable or non heat sealable. In one embodiment, if the first skin layer 10 and/or the second skin layer 18 are not heat sealable, then a heat sealable layer (not shown) may be applied to the first skin layer 10 and/or the second skin layer 18. A heat sealable layer (not shown) may be, for example, vinylidene chloride polymer or an acrylic polymer; or heat sealable layer (not shown) may be coextruded from any of the heat sealable materials described for the first skin layer 10 and/or the second skin layer 18. Vinylidene chloride polymer or acrylic polymer coating may also be applied to the exposed first surface 11 or the second surface 19. In one embodiment, if the first surface 11 and/or the second surface 19 are a matte surface, then that matte surface may not be heat sealable.

In another embodiment, if the first skin layer 10 and/or the second skin layer 18 are heat sealable, it may be fabricated from any of the heat sealable copolymers, blends of homopolymers and blends of copolymer(s) and homopolymer(s) heretofore employed for this purpose. Illustrative heat sealable copolymers which may be used for the first skin layer 10 and/or the second skin layer 18 of the present film comprise ethylene-propylene copolymers containing from about 1.5 to about 12, and alternatively from about 3 to about 7 weight percent ethylene and ethylene-propylene-butene terpolymers containing from about 1 to about 10, and alternatively from about 1 to about 6 weight percent ethylene and from about 70 to about 97. In another embodiment, heat sealable blends of homopolymer may be utilized for the first skin layer 10 and/or the second skin layer 18 which include from about 1 to about 99 weight percent polypropylene homopolymer, e.g., one which is the same as, or different from, the polypropylene homopolymer constituting core layer 14 blended with from about 99 to about 1 weight percent of a linear low density polyethylene (LLDPE). If the first skin layer 10 and/or the second skin layer 18 are heat-sealable, corona or flame treatment of that layer may be optionally included.

In another embodiment, heat sealable blends of copolymer(s) and homopolymer(s) which may be used for the first skin layer 10 and/or the second skin layer 18 include: a blend of from about 5 to about 19 weight percent of polybutylene and from about 95 to about 81 weight percent of a copolymer of propylene (80 to about 95 mole percent) and butylene (20 to about 5 mole percent); a blend of from about 10 to about 90 weight percent of polybutylene and from about 90 to about 10 weight percent of a copolymer of ethylene (2 to about 49 mole percent) and a higher olefin having 4 or more carbon atoms (98 to about 51 mole percent); a blend of from about 10 to about 90 weight percent polybutylene and from about 90 to about 10 weight percent of a copolymer of ethylene (10 to about 97 mole percent) and propylene (90 to about 3 mole percent); and, a blend of from about 90 to about 10 weight percent of polybutylene, and from about 10 to about 90 weight percent of a copolymer of propylene (2 to about 79 mole percent) and butylene (98 to about 21 mole percent).

In one embodiment, the first skin layer 10, first transition layer 12, core layer 14, second transition layer 16, and second skin layer 18 may be coextruded. Thereafter, the film may be uniaxially or biaxially oriented. For example, when the core layer and the skin layer(s) comprise polypropylene, a machine direction orientation may be preferably from about 4 to about 8 and a transverse direction orientation may be preferably from 4 to about 10 times, at a drawing temperature of about 100° C. to about 170° C. to yield a biaxially oriented film. In one embodiment, the film thickness may be from about 0.5 mil to about 3.5 mils.

The first skin layer 10 and/or the second skin layer 18 of films according to this invention may also include a polydialkylsiloxane additive. The polydialkylsiloxane additive is especially selected because it reduces the friction between the first surface 11 and/or the second surface 19 and the machine surfaces with which the first surface 11 and/or the second surface 19 comes into contact during processing, while maintaining the “matte” appearance of the film. The polydialkylsiloxane additive also reduces the accumulation of resin on the die surfaces during extrusion, which minimizes this resin accumulation, commonly referred to as “die drool.” This is useful because it reduces the frequency for die cleaning and the chance for film breakage. The polydialkylsiloxane additive mitigates this effect.

In one embodiment of the invention, first skin layer 10 and/or the second skin layer 18 are compounded with an amount of a polydialkylsiloxane sufficient to reduce friction when the film is formed and/or when it is manipulated in packaging machinery.

Sometimes may be useful to enhance film properties or provide the matte film with certain characteristic or physical properties through addition of appropriate film additives. Such additives may be used in varying amounts, depending upon the property required, and may be typically selected from a group comprising: antiblock, slip additive, antioxidant additive, antistatic, moisture barrier additive and/or gas barrier additive. These additives may be included in any of the film's layers. Useful antistatic additives, which may be used in amounts ranging from about 0.05 to about 3 weight %, based upon the weight of the layer, may include alkali metal sulfonates, polyether-modified polydiorganosiloxanes, polyalkylphenylsiloxanes and tertiary amines. Useful antiblock additives may be used in amounts ranging from about 0.1 weight % to about 3 weight % based upon the entire weight of the layer may include inorganic particulates such as silicon dioxide, e.g. a particulate antiblock sold by W. R. Grace under the trademark “SIPERNAT 44,” calcium carbonate, magnesium silicate, aluminum silicate, calcium phosphate, and the like, e.g., KAOPOLITE. Another useful particulate antiblock agent is referred to as a non-meltable crosslinked silicone resin powder sold under the trademark “TOSPEARL” made by Toshiba Silicone Co., Ltd. and is described in U.S. Pat. No. 4,769,418. Another useful antiblock additive is a spherical particle made from methyl methacrylate resin having an average diameter of 1 to 15 microns, such an additive is sold under the trademark “EPOSTAR” and is commercially available from Nippon Shokubai. Typical slip additives may include higher aliphatic acid amides, higher aliphatic acid esters, waxes and metal soaps, which may be used in amounts ranging from about 0.1 to about 2 weight percent based on the total weight of the layer. A specific example of a useful fatty amide slip additive is erucamide. Useful antioxidants may be generally used in amounts ranging from about 0.1 weight % to about 2 weight percent, based on the total weight of the layer, phenolic antioxidants. One useful antioxidant is commercially available under the trademark “Irganox 1010”. Barrier additives may be used in useful amounts and may include low-molecular weight resins, hydrocarbon resins, particularly petroleum resins, styrene resins, cyclopentadiene resins and terpene resins. Optionally, one or more of the film's layers may be compounded with a wax for lubricity. Amounts of wax range may from about 2 to about 15 weight % based on the total weight of the layer. Any conventional wax useful in thermoplastic films is contemplated.

Although various embodiments have been disclosed for the five layer film 50, three layer film 30, four layer film 40, and two layer film 20, additional embodiments of films with two or more layers are possible by interchanging elements of matte producing agents, polyolefins, and inorganic and organic additives that would be clear to one with ordinary skill in the art.

The following examples illustrate the present invention which were produced using a known film production process:

### EXAMPLE #1

| | | | |
|---|---|---|---|
| D layer | 1-2 | ga. | EP copolymer (3.5% ethylene) (Fina 8573) |
| C layer | 10 | ga | EP copolymer (3.5% ethylene) + 20% CaCO3 |
| | | | (3 μm) (Fina 8573 + Schulman PF92D) |
| B layer | 85 | ga. | PP homopolymer (Fina 3371) |
| A layer | 4 | ga. | PP homopolymer + antiblock (Fina 3371 + |
| | | | Syloblock 44) |

### EXAMPLE #2

| | | | |
|---|---|---|---|
| D layer | 1-2 | ga. | EP copolymer (3.5% ethylene) (Fina 8573) |
| C layer | 20 | ga | EP copolymer (3.5% ethylene) + 20% CaCO3 |
| | | | (3 μm) (Fina 8573 + Schulman PF92D) |
| B layer | 75 | ga. | PP homopolymer (Fina 3371) |
| A layer | 4 | ga. | PP homopolymer + antiblock (Fina 3371 + |
| | | | Syloblock 44) |

### EXAMPLE #3

| | | | |
|---|---|---|---|
| D layer | 1-2 | ga. | EP copolymer (3.5% ethylene) (Fina 8573) |
| C layer | 20 | ga | EP copolymer (3.5% ethylene) + 19% CaCO3 |
| | | | (3 μm) + 1% particles >3 μm (Fina 8573 + |
| | | | Schulman H5228) |
| B layer | 75 | ga. | PP homopolymer (Fina 3371) |
| A layer | 4 | ga. | PP homopolymer + antiblock (Fina 3371 + |
| | | | Syloblock 44) |

### COMPARATIVE EXAMPLE #1

| | | | |
|---|---|---|---|
| D layer | 1-2 | ga. | EP copolymer (3.5% ethylene) (Fina 8573) |
| C layer | 10 | ga | Homopolymer PP + 20% CaCO3 (3 μm) |
| | | | (Fina 3371 + Schulman PF92D) |
| B layer | 85 | ga. | PP homopolymer (Fina 3371) |
| A layer | 4 | ga. | PP homopolymer + antiblock (Fina 3371 + |
| | | | Syloblock 44) |

### COMPARATIVE EXAMPLE #2

| | | | |
|---|---|---|---|
| D layer | 1-2 | ga. | EP copolymer (3.5% ethylene) (Fina 8573) |
| C layer | 20 | ga | Homopolymer PP + 20% CaCO3 (3 μm) |
| | | | (Fina 3371 + Schulman PF92D) |
| B layer | 75 | ga. | PP homopolymer (Fina 3371) |
| A layer | 4 | ga. | PP homopolymer + antiblock (Fina 3371 + |
| | | | Syloblock 44) |

Properties

| | | Light | | Roughness | CaCO3 |
|---|---|---|---|---|---|
| | Haze | Transmission | Gloss | Ra | anchorage |
| Example #1: | 34% | | 44% | 13μ inch | No loose particles |
| Example #2: | 48% | | 28% | 16μ inch | No loose particles |
| Example #3: | 46% | | 37% | 22μ inch | No loose particles |
| Comparative | | 59% | 30% | 22μ inch | Loose particles |
| Ex. #1: | | | | | |
| Comparative | | 47% | 36% | 19μ inch | Loose particles |
| Ex. #2: | | | | | |

Examination of the examples demonstrates that:

By selecting the right polymer in which the particles are incorporated, it is possible to provide a matte film (having a rough surface) that is not opaque (allows the reverse print to be visible).

The matte roughness may be adjusted by varying the particle size and/or the layer thickness.

A thicker outer layer may reduce the roughness of the film.

It is possible to tailor the contact clarity by choosing a softer layer in which the particles are incorporated.

Matte producing agent particles incorporated in a traditionally cavitated polymer layer yields some loose particles, even when the particle containing layer is covered by a thin outer layer.

Matte producing agent particles incorporated in a copolymer layer would not give loose particles even if not covered by an outer thin layer.

Haze measurements were made using a Hazemeter, such as the BKY-Gardner XL-211 Haze-Guard and Haze-Guard Plus hazemeters, consistent with ASTM guidelines, including ASTM Dl 003. Gloss was determined in accordance with ASTM procedure D 2457, with the angle of incidence set at 45 degrees. A light beam hits the planar test surface at the set angle of incidence and is reflected or scattered thereby. A sensor measures the amount of light reflected by the film at a mirror image angle. The gloss value is the ratio of the reflected light to the incident light. Roughness was measured using a Perthometer instrument and was reported as the average roughness. Melt flow index was measured in accordance with DIN 53 735 at a load of 21.6 N and at 230 degrees C. for polypropylene resins and at 190 degrees C. for polyethylene resins.

We claim:

1. A multi-layered polymeric film comprising:
(a) a core layer comprising a polyolefin, wherein the core layer comprises an interior of the film;
(b) a first skin layer comprising a low melting point polyolefin and a matte producing agent, wherein the first skin layer is engaged with and exterior to the core layer.

2. The film of claim 1 wherein the core layer comprises a material selected from the group consisting of polypropylene and polyethylene.

3. The film of claim 1 wherein the matte producing agent is selected from the group consisting of aluminum oxide, aluminum sulfate, barium sulfate, calcium carbonate, magnesium carbonate, aluminum silicate (kaolin clay), magnesium silicate (talc), silicon dioxide, titanium dioxide, and mixtures thereof.

4. The film of claim 1 wherein the matte producing agent comprises calcium carbonate.

5. The film of claim 1 wherein the core layer comprises high density polyethylene.

6. The film of claim 1 wherein the core layer comprises isotactic polypropylene.

7. The film of claim 1 wherein a melting point of the core layer is at least about 5° C. higher than a melting point of the low melting point polyolefin.

8. The film of claim 1 wherein the film is oriented while the low melting point polyolefin is at a temperature equal to or greater than the melting point of the low melting point polyolefin.

9. The film of claim 8 further comprising:
an additional outer layer engaged with an exterior side of the first skin layer.

10. The film of claim 1 wherein the multi-layered polymeric film is substantially non-opaque having a haze of equal to or less than about 50%.

11. A multi-layered polymeric film comprising:
(a) a core layer comprising a polyolefin, wherein the core layer comprises an interior of the film;
(b) a first transition layer comprising a low melting point polyolefin and a matte producing agent, wherein the first transition layer is exterior to the core layer;
(c) a first skin layer comprising a polyolefin, wherein the first skin layer is exterior to the core layer and the first transition layer.

12. The film of claim 11 wherein the polyolefin of the first skin layer is a low melting point polyolefin.

13. The film of claim 11 further comprising:
a second skin layer comprising a low melting point polyolefin, wherein the second skin layer is exterior to the core layer on a side of the core layer opposite the first transition layer and the first skin layer.

14. The film of claim 11 further comprising:
a second transition layer comprising a low melting point polyolefin, wherein the second transition layer is exterior to the core layer on a side of the core layer opposite the first transition layer and the first skin layer; and
a second skin layer comprising a low melting point polyolefin, wherein the second skin layer is exterior to the core layer and the second transition layer.

15. The film of claim 11 wherein the core layer comprises a material selected from the group consisting of polypropylene and polyethylene.

16. The film of claim 15 wherein the core layer comprises a material selected from the group consisting of isotactic polypropylene and HDPE.

17. The film of claim 11 wherein the matte producing agent of the first transition layer is selected from the group consisting of aluminum oxide, aluminum sulfate, barium sulfate, calcium carbonate, magnesium carbonate, aluminum silicate (kaolin clay), magnesium silicate (talc), silicon dioxide, titanium dioxide, and mixtures thereof.

18. The film of claim 11 wherein the matte producing agent of the first transition layer comprises calcium carbonate.

19. The film of claim 11 wherein the low melting point polyolefin has a melting point at least about 5° C. less than the melting point of the polyolefin of the core layer.

20. The film of claim 13 wherein the second skin layer comprises a low melting point polyolefin and a matte producing agent.

21. The film of claim 13 wherein the second transition layer comprises a low melting point polyolefin and a matte producing agent.

22. A multi-layered polymeric film comprising:
(a) a core layer comprising a polyolefin, wherein the core layer comprises an interior of the film;
(b) a first transition layer comprising polyolefin agent, wherein the first transition layer is exterior to the core layer;
(c) a first skin layer comprising a low melting point polyolefin, wherein the first skin layer is exterior to the core layer and the first transition layer.

23. A method of producing a multi-layered film comprising the steps of:
(a) coextruding a skin layer comprising a low melting point polyolefin and a matte producing agent, with a core layer comprising a polyolefin; and
(b) orienting the coextruded skin layer and core layer in the machine direction at an elevated temperature, wherein the elevated temperature is at least about the melting point of the low melting point polyolefin.

24. The film of claim 23 further comprising:
orienting the skin layer and the core layer in the transverse direction at an elevated temperature, wherein the elevated temperature is at least about the melting point of the low melting point polyolefin.

25. A multi-layered polymeric film comprising:
(a) a core layer comprising a polyolefin having a first side and a second side;
(b) a first transition layer comprising a low melting point polyolefin and a matte producing agent having a first side and a second side wherein the second side of the first transition layer is adjacent to the first side of the core layer;
(c) a first skin layer comprising a polyolefin having a first side and a second side wherein the second side of the first skin layer is adjacent to the first side of the first transition layer.

26. The film of claim 25 further comprising a second skin layer comprising a polyolefin having a first side and a second side wherein the first side of the second skin layer is adjacent to the second side of the core layer.

27. The film of claim 25 further comprising a second transition layer comprising a polyolefin wherein the second transition layer has a first side and a second side wherein the first side of the second transition layer is adjacent to the second side of the core layer, and further comprising a second skin layer comprising a polyolefin wherein the second skin layer has a first side and a second side wherein the first side of the second skin layer is adjacent to the second side of the second transition layer.

28. The film of claim 26 wherein the second skin layer comprises a low melting point polyolefin and a matte producing agent.

29. The film of claim 26 wherein the second transition layer comprises a low melting point polyolefin and a matte producing agent.
